(19) United States
(12) Patent Application Publication
(10) Pub. No.: US 2015/0135890 A1
(43) Pub. Date: May 21, 2015

(54) LEVER REMOTE LOCKING FOR FIFTH WHEEL MANEUVER

(71) Applicant: Naira Maschio, Boqueirao-Curitiba (BR)

(72) Inventor: Adriana PERTILE, Boqueirao - Curitiba (BR)

(21) Appl. No.: 14/534,809

(22) Filed: Nov. 6, 2014

(30) Foreign Application Priority Data
Nov. 6, 2013 (BR) 102013028578-1

(51) Int. Cl. B62D 53/10

(52) U.S. Cl. CPC B62D 53/10
USPC 74/532

(57) ABSTRACT

The present invention is described as a remote lock for fifth wheel handle lever which, in accordance with its characteristics, provides the formation of a remote lock (1) in a proper and specific electromechanical structure with direct actuation in the handle lever (D) of fifth wheels (A) which precludes undue disengagement or uncoupling between the tractor (B) and the semi-trailer (C) of the wagons, so as to enable in an extremely practical, safe, and accurate fashion the complete optimization of the set of procedures intended for disengagement or uncoupling between the tractor (B) and the semi-trailer (C) through direct actuation of the handle lever (D) drive lock controlling the fifth wheel locking mechanism (A), resulting in precluded locking bar retraction (F), keeping the locking claw (G) in closed position and, therefore, still attached to the kingpin (H) of the semi-trailer (C).

The present invention relates to accessories for road implements in general, more specifically to a remote lock for fifth wheel handle lever which, in accordance with its general characteristics, has as main objective to provide the formation of a remote lock in a proper and specific electromechanical structure with direct actuation in the fifth wheel handle lever which precludes undue disengagement or uncoupling between the tractor and the semi-trailer truck, so as to enable in an extremely practical, safe, and accurate fashion the complete optimization of the set of procedures intended for disengagement or uncoupling between the tractor and the semi-trailer by directly actuating the drive lock of the handle lever controlling the fifth wheel locking mechanism, resulting in precluded locking bar retraction, keeping the locking claw in closed position and, therefore, still attached to the semi-trailer kingpin and, having as base, a remote lock with great resistance, safety, and versatility. With specific design and shape, and easy access to the best accommodation and safety for users, practical handling and functionality features, very cost-effective and, due to its general characteristics and dimensions, easily adaptable to a wide range of fifth wheel tractor vehicles, semi-trailers, users and sites in general, whichever characteristics they feature.

It is important to notice that the fifth wheel is an accessory attached to cargo vehicles in general, more specifically to wagons so as to connect the tractor to the semi-trailer, being comprised of a structure made of nodular fixed cast iron parallel over the tractor rear deck attaching to perpendicular kingpin fixed under semi-trailer frontal part—the kingpin is responsible for engaging the semi-trailer to the tractor through the fifth wheel. Its locking assembly is comprised of a handle lever, a locking bar lever, a locking bar, and a locking claw.

A typical coupling operation of a tractor that has a fifth wheel installed on the back part of its chassis, occurring with a handle lever of the fifth wheel arranged in open position. Once this is done, the tractor is set to reverse gear towards the front part of the semi-trailer so that the semi-trailer kingpin is engaged to the fifth wheel and automatically locks the fifth wheel.

However, a typical uncoupling operation of a tractor that has installed a fifth wheel on the back part of its chassis occurs with the handle lever of the fifth wheel arranged in open position. Once this is done, the tractor is set to forward gear opposite to the front part of the semi-trailer—moving away from the semi-trailer so that the semi-trailer kingpin disengages from the fifth wheel and keeps handle lever in open position until another semi-trailer is coupled.

Due to significant increase in road transport regarding cargo transportation, combined with enormously higher cargo theft rates, mainly wagons formed by tractor and semi-trailer, keeping the semi-trailer attached to the tractor, even when the latter is remotely blocked by an embedded tracking system, significantly increasing the success in a cargo recovery.

It is presently known in the art some few systems or equipment which actuate in locking the fifth wheel locking bar, also resulting in restricted disengagement between tractor and semi-trailer; however, to do so, in all cases it is needed a direct intervention in road implement—fifth wheel, so as to replace the original parts by other parts duly prepared to work in conjunction with a traction solenoid.

Regarding this, it has become indispensable for individual carriers and transport companies, mainly those using wagons formed by tractor and semi-trailer generally attached by a fifth wheel, the organization of a versatile, practical, and safe structure able to preclude undue disengagement or uncoupling between tractor and semi-trailer truck in most diverse sites.

In a broad analysis of the literature in order to set the current state of art facing systems or equipment able to preclude undue disengagement or uncoupling between tractor and semi-trailer truck, object of the present invention, documents regarding the state of the art relating the specific object claimed in the present invention were not disclosed, i. e., a remote lock actuating directly in handle lever drive lock controlling the fifth wheel locking mechanism, resulting in precluded locking bar retraction, keeping the locking claw in closed position.

Thus, the overall design of the present remote lock for fifth wheel handle lever, object of the present invention, is fully based in its simple and robust structure with minimal needed components and very simplified, safe, and optimized operability, combined with very practical manufacture and maintenance procedures, so as to generate a practical and efficient remote lock capable of actuating the drive lock of the handle lever controlling the fifth wheel locking mechanism, thus precluding undue disengagement or uncoupling between tractor and semi-trailer.

More specifically, the total precluding of the disengagement or uncoupling between tractor and semi-trailer is achieved directly through the application of remote locking to the fifth wheel, more specifically a fifth wheel handle lever, so as to cause a direct actuation of the handle lever which completely restricts its movements, i. e., thus resulting in precluded locking bar retraction, which will keep the locking claw in closed position and, therefore, still attached to the semi-trailer kingpin.

The remote lock for fifth wheel handle lever has its operating principle linked to the board network embedded in the cargo vehicle—wagon, to the fleet tracking system, this being comprised of a communication element installed in the cargo vehicle—wagon, which communicates with the operational base through a data transmission network such as, e. g., cell phone, satellite or the like. Connected to such communication element is an onboard computer to which peripheral and sensors are attached allowing data collection and remote actuation in points of the cargo vehicle—wagon, thus allowing the operational base to have control over both fleet and cargo.

More specifically, a remote lock for fifth wheel handle lever, as is installed and operated, is considered a locking peripheral for the fleet tracking system embedded in a cargo vehicle—wagon, since it precludes through a remote command, actuated from the operational base and transmitted by a fleet tracking system, the electromechanical locking between tractor and semi-trailer.

The present invention is characterized by the union of components and processes in a novel concept, which will meet the diverse demands the nature of the use requires, i. e., precluding the undue disengagement or uncoupling between tractor and semi-trailer by remotely locking the fifth wheel handle lever. Such concept assures a remote lock of great efficiency, functionality, resistance, durability, safety, versatility, accuracy and ergonomics due to excellent aggregated technical qualities, which provides advantages and improvements in operational locking procedures of the fifth wheel handle lever and, which general characteristics differ from other shapes and models of fifth wheel locks or locking systems known by the state of the art.

The present invention consists of employing a modern, efficient, safe, and functional remote lock for fifth wheel handle lever comprised of an assembly of electromechanical and vehicular solutions properly built in, compounding a complete and novel remote lock with exclusive design, great finishing details, good aesthetics and specific characteristics, which incorporates a characteristic and specific structure of electromechanical type, high durability and resistance, and perfectly integrated with fleet tracking system embedded in a cargo vehicle such as its locking peripheral, and symmetrically arranged therebetween along with a fifth wheel of a cargo vehicle a box as packing element of the remote lock components, a locking pin as actuation element in the fifth wheel handle lever, an electric motor as movement element of the locking pin, a magnetic field reader as positioning identification element of the locking pin, and an electronic board as an element for movement control of the electric motor and data analysis of the magnetic field reader, so as to enable forming a single, complete, and safe assembly, which shapes and internal and external arrangements enabling the perfect adaptation to a wide range of fifth wheels, tractors, and semi-trailers, being specially designed for such purposes.

The present remote lock is based on the application of components and processes in a novel concept, however, without reaching a high level of sophistication and complexity, thus making possible to solve some of the main inconveniencies of the other shapes and models widely known in the art and employed in precluding undue disengagement or uncoupling between tractor and semi-trailer truck—locking of fifth wheel lever, which are situated in a work range in which the difficulties of use and application, the low efficiency and performance and accidents are very frequent and the shapes and/or models are either based on simple adaptations, therefore being highly unsafe, of great deterioration and fragility, short durability and resistance, low versatility, high inaccuracy, laborious in application, high losses, low yielding, and negligible performance, or are very large, costly, of high volume and general weight, low flexibility, complex handling, high maintenance, large waste of time, high losses, complex manufacture, and low performance.

The objectives, advantages, and other important characteristics of the present invention will be easily understood when taken in conjunction with the appended figures, in which:

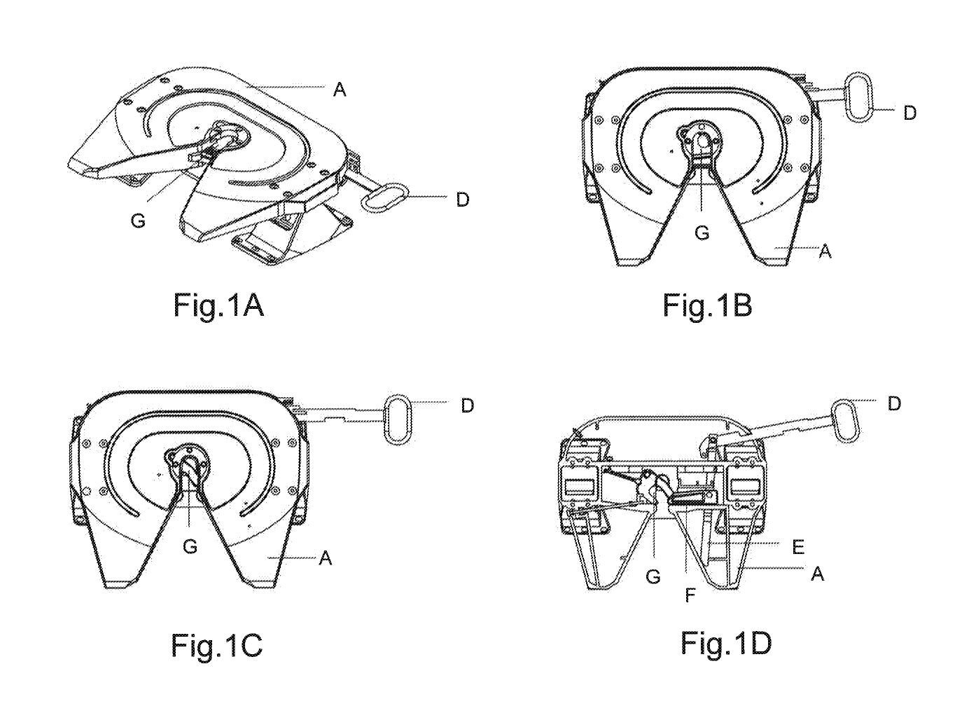

FIG. 1A depicts a front perspective view of a type of fifth wheel known in the art—closed position of the handle lever.

FIG. 1B depicts a top view of a type of fifth wheel known in the art—open position of the handle lever.

FIG. 1C depicts a top view of a type of fifth wheel known in the art—closed position of the handle lever.

FIG. 1D depicts a top cross-sectional view of a type of fifth wheel known in the art—open position of the handle lever.

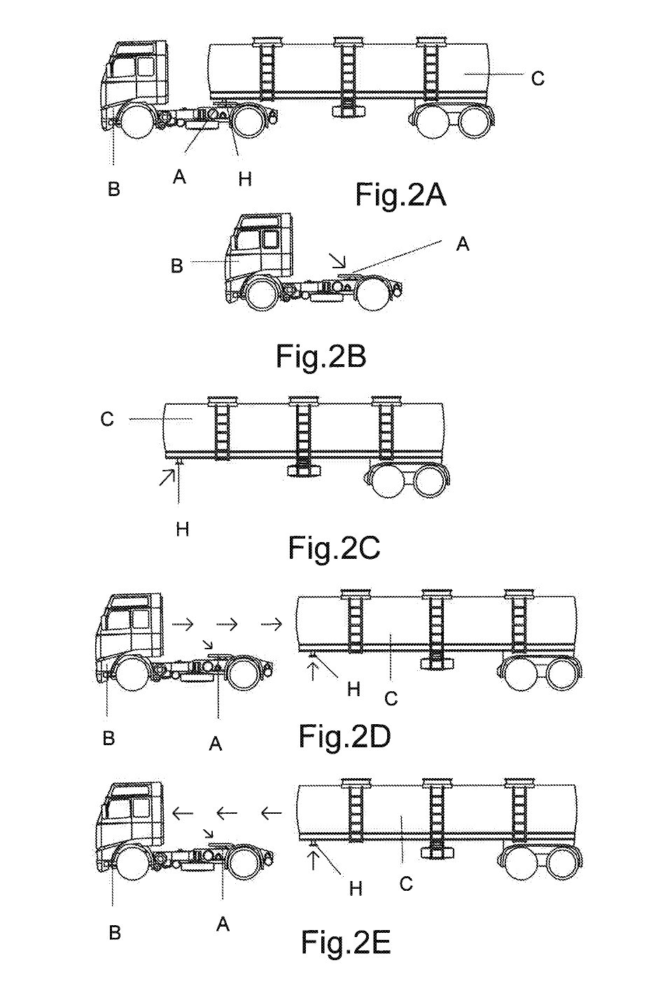

FIG. 2A depicts a perspective view of a cargo vehicle comprised of duly coupled tractor and semi-trailer.

FIG. 2B depicts a perspective view of an isolated tractor—highlighting the fifth wheel over the back part of the chassis.

FIG. 2C depicts a perspective view of an isolated semi-trailer—highlighting the kingpin over the front part thereof.

FIG. 2D depicts a perspective view of a cargo vehicle comprised of tractor and semi-trailer in coupling procedure.

FIG. 2E depicts a perspective view of a cargo vehicle comprised of tractor and semi-trailer in uncoupling procedure.

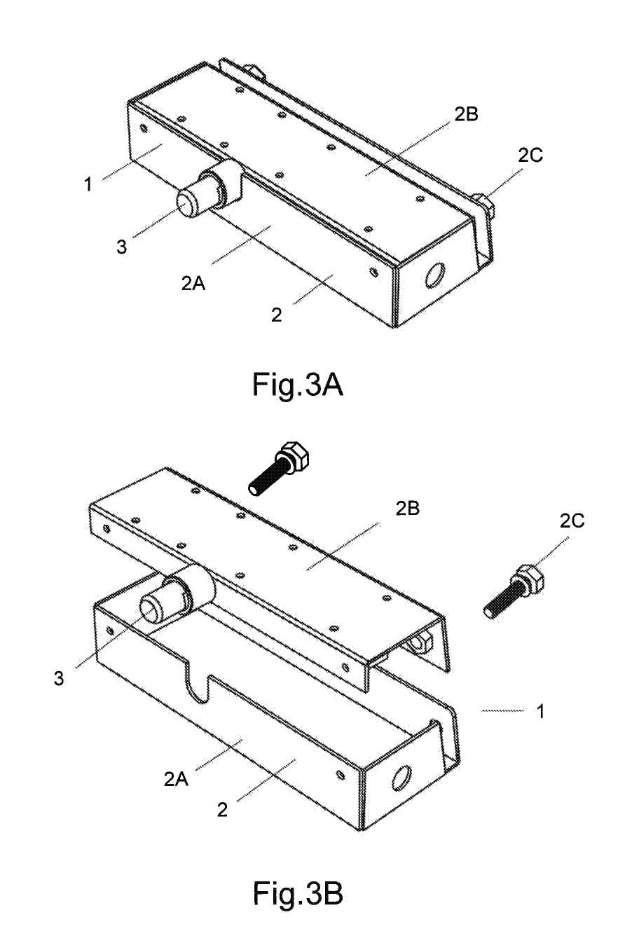

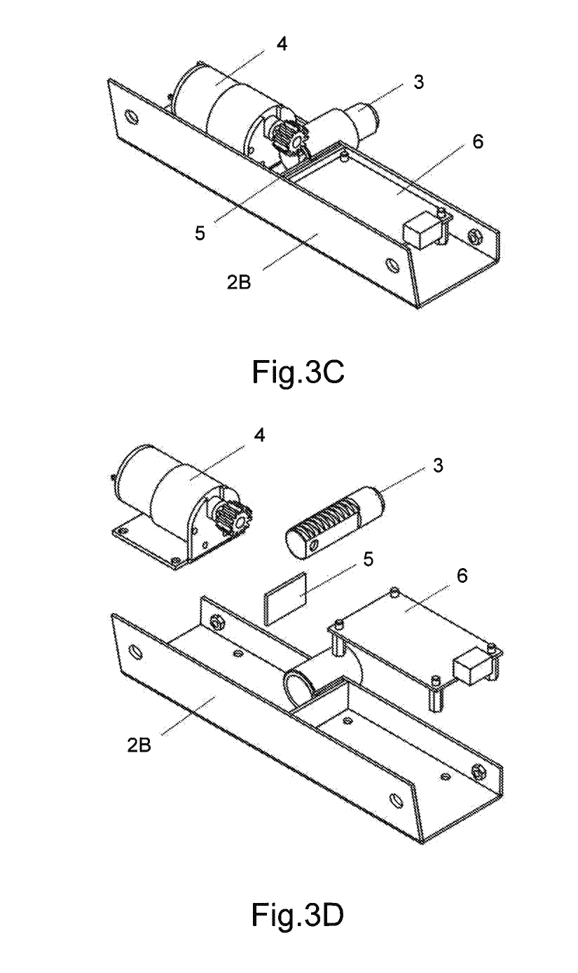

FIG. 3A depicts a perspective view of the remote lock for fifth wheel handle lever.

FIG. 3B depicts an exploded perspective view of the remote lock for fifth wheel handle lever.

FIG. 3C depicts a bottom perspective view of the remote lock cover for fifth wheel handle lever showing the electromechanical components.

FIG. 3D depicts an exploded bottom perspective view of the cover and the electromechanical components of the remote lock for fifth wheel handle lever.

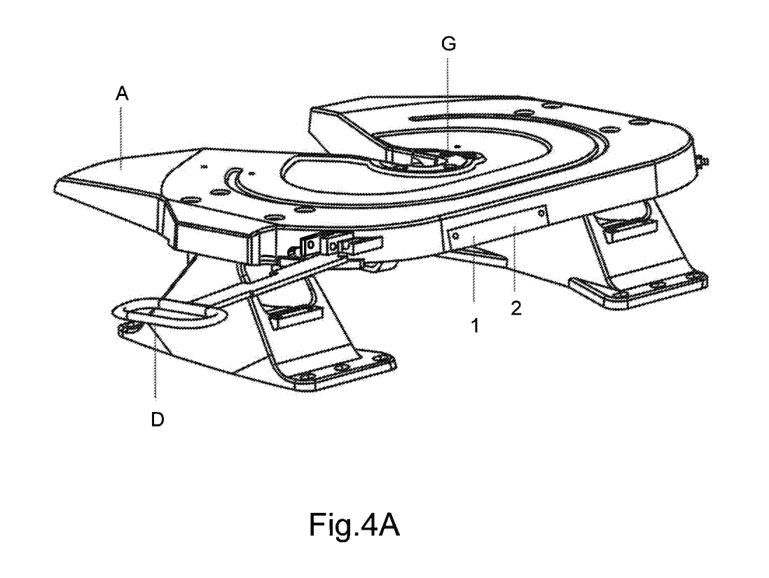

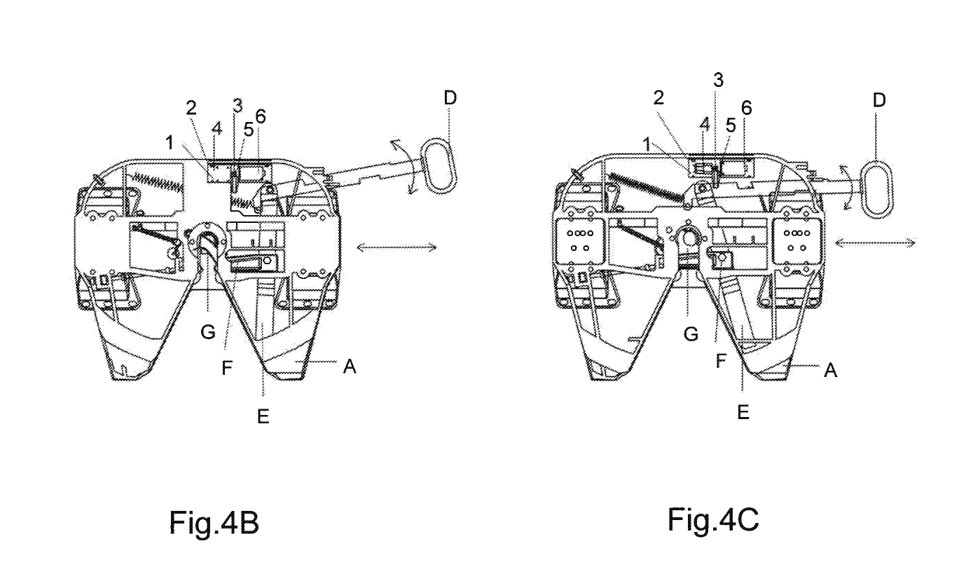

FIG. 4A depicts a back perspective view of a type of fifth wheel with a remote lock for fifth wheel handle lever installed—open position of the handle lever.

FIG. 4B depicts a top section view of a type of fifth wheel with a remote lock for fifth wheel handle lever installed—open position of the handle lever.

FIG. 4C depicts a top section view of a type of fifth wheel with a remote lock for fifth wheel handle lever installed—position of the handle lever in closed position of the handle lever.

As inferred in the appended figures illustrating and integrating the present specification of the patent of invention of “Remote lock for fifth wheel handle lever”, in FIG. 1) is generally presented to which, comprised of a remote lock (1) complete and with specific characteristics, which embodies a specific structure of electromechanical type, high durability and resistance, internal and external shapes and arrangements adapting to a wide range of fifth wheels (A), tractors (B) and semi-trailers (C) in general, arranged vertically and symmetrically fitted in the front part of the fifth wheel (A), and containing, perfectly integrated and symmetrically arranged therebetween, a box (2) arranged vertically and symmetrically fitted in the front part of the fifth wheel (A) and having a base (2A) arranged horizontally and symmetrically all along the extension of the box (2), a cover (2B) arranged horizontally, alongside and symmetrically fitted over and all along the extension of the base (2A) and an assembly of attachment devices (2C) arranged perpendicularly and symmetrically between a box (2) and a base of the fifth wheel (A), with a primary function of packing the electromechanical components of the remote lock (1); a locking pin (3) arranged horizontally, alongside and symmetrically centered under the internal face of the cover (2B) and trespassing the back faces of the box (2)—base (2A) and cover (2B), with a primary function of actuating the handle lever (D) of the fifth wheel (A) which, in its turn, actuates in sequence in the locking bar lever (E), locking bar (F) and locking claw (G) inside the fifth wheel (A); an electric motor (4) arranged horizontally, alongside and symmetrically under an internal face of the cover (2B), with a primary function of moving the locking pin (3)—forward and backward; a magnetic field reader (5) arranged vertically, perpendicularly and symmetrically under the internal face of the cover (2B), with a primary function of identifying its position (3)—forward or backward; and an electronic board (6) arranged horizontally, alongside and symmetrically under the internal face of the cover (2B), with a primary function of controlling the movement of the electric motor (4) and analyzing data from magnetic field reader (5); and wherein the remote lock (1) is directly connected to the board network embedded in the cargo vehicle—wagon to the fleet tracking system basically integrated by a communication element and an onboard computer, i. e., a remote locking peripheral of this fleet tracking system, with a primary function of receiving/transmitting commands and opening/closure information from the fifth wheel (A) between the remote lock (1) and the operational base.

The remote lock for fifth wheel handle lever has its functioning based on the correct installation along with the front part of the fifth wheel (A). When receiving the command remotely sent to the communication element and data traffic, the onboard computer sent a signal to the electronic board (6), installed inside the remote lock (1), which acknowledges the authenticity of the command and energizes the electric motor (4), causing the locking pin (3) to move to the position closed or open, which in its turn restricts the movement of the handle lever (D), thus resulting in precluding the disengagement between the tractor (B) and the semi-trailer (C).

More specifically, in order to operate, the remote lock (1) must have a validated command, by means of the board network specific protocol of the fleet tracking system embedded in cargo vehicle—wagon. The command sent by the tracking system is validated in the electronic board (6) which in its turn releases energy for the electric motor (4) to move the locking pin (3), i. e., clockwise, moves the locking pin (3) out of the box (2), and counterclockwise, moves the locking pin (3) into the box (2). The positioning of the locking pin (3) is identified by the electronic board (6) by means of the magnetic field reader (5).

This validation from the electronic board (6) allows the guarantee of robustness of the remote lock (1), since the electric motor (3) is only actuated when a valid command is noticed by the electronic board (6), thus keeping non authorized interventions in the board network of the fleet tracking system from provide energy to said electric motor (3).

It must be emphasized that the basic embodiment in which the remote lock (1) operates as a peripheral of the fleet tracking system—the monitoring and remote control of fleets is directly related to the characteristics each service provider will confer it.

It should also be stressed that the remote lock for fifth wheel handle lever is based in a model of fifth wheel of type JOST—37C, non-restrictive or limitative facing the object claimed, i. e., it can be applied in a wide range of fifth wheels with or without small adaptations that do not alter its general concept.

Since the remote lock for fifth wheel handle lever has its components fully integrated between itself and the fifth wheel (A), it is rapidly assembled and disassembled, nothing is unpinned, broken or bent, reaches high performance and efficiency levels, combined with high durability and absolute safety. After being fully integrated between itself and the fifth wheel (A), the components are trapped and cohesive, thus being kept from loosen up when in use, keeping the assembly fully available for the set of procedures of precluding undue disengagement or uncoupling between the tractor (B) and the semi-trailer (C) of the wagons—locking of the fifth wheel (A) and, consequently, of the semi-trailer relative to the tractor. Thus, the remote lock (1) can be used without any concerns, mainly regarding durability and safety of its components, as well as the safety of the users.

For all the foregoing, it is an electromechanical device for road implements that will be well received by cargo vehicle drivers and transport companies in general, since the remote lock for fifth wheel handle lever presents a number of advantages, such as: great safety, reliability and fast application; great efficiency and performance in its application in virtue of its general concept; very comfortable, convenient and safe to users; very high resistance and general durability, allied to low or no wearing of the assembly as a whole; fully accessible costs which enables great cost-efficacy; practical and safe use by any cargo vehicle driver; wide reaching range; inexpensive and practical general maintenance; perfect and seamless adaptation to most diverse types fifth wheels (A), as well as tractors (B) and semi-trailers (C); high operational accuracy; great assembly motility and flexibility; high operational ergonomics; and the certainty of having an electromechanical device that fully meets current laws and standards and basic conditions necessary to its application.

All these attributes permit consider the remote lock for fifth wheel handle lever as a fully versatile, efficient, practical, and safe means to be applied to a wide range of fifth wheels of the most diverse types of tractors (B) and semi-trailers (C) in general, by most diverse cargo vehicles drivers in general, and in most diverse types of places, regardless of the general characteristics those might present, also being of great easiness of application and handling, allied to great performance and excellent general characteristics; however, the measures, sizes and amounts may vary in accordance with the needs for each of the applications.

1. A lever remote locking for fifth wheel maneuver, characterized by comprising a remote lock (1) incorporating an electromechanical structure, arranged vertically and symmetrically in the front part of the fifth wheel (A) and directly applied to a board network embedded in the cargo vehicle—wagon, to the fleet tracking system basically integrated to a communication element and an onboard computer, i. e., a remote locking peripheral of such fleet tracking system.

2. The lever remote locking for fifth wheel maneuver according to claim 1, characterized by comprising a remote lock (1) incorporating an electromechanical structure containing integrated and symmetrically arranged therebetween a box (2) arranged vertically and symmetrically in the front part of the fifth wheel (A) and having a base (2A) arranged horizontally and symmetrically all along the extension of the box (2), a cover (2B) arranged horizontally, alongside and symmetrically over and all along the whole extension of the base (2A) and an assembly of attachment devices (2C) arranged perpendicularly and symmetrically between the box (2) and the base of the fifth wheel (A); a locking pin (3) arranged horizontally, alongside and symmetrically centered under the internal face of the cover (2B) and trespassing the back faces of the box (2)—base (2A) and cover (2B); an electric motor (4) arranged horizontally, alongside and symmetrically under the internal face of the cover (2B); a magnetic field reader (5) arranged vertically, perpendicularly and symmetrically under the internal face of the cover (2B); and an electronic board (6) arranged horizontally, alongside and symmetrically under the internal face of the cover (2B).
